(19) United States
(12) Patent Application Publication
(10) Pub. No.: US 2026/0180975 A1
(43) Pub. Date: Jun. 25, 2026

(54) USER SESSION AGGREGATOR USING DIFFERENT IDPS AND DIFFERENT SESSION MANAGEMENT PROTOCOLS

(71) Applicant: Lenovo Global Technology (United States) Inc., Morrisville, NC (US)

(72) Inventors: Florin - Bogdan Mihalache, Bucharest (RO); Tiberius-Ionut Hodoroaba-Simion, Bucharest (RO); Alexandru Cozma, Bucharest (RO)

(21) Appl. No.: 18/988,206

(22) Filed: Dec. 19, 2024

(51) Int. Cl. H04L 9/40

(52) U.S. Cl. CPC H04L 63/083

(57) ABSTRACT

A method for user session aggregator using different IDPs and different session management protocols is disclosed. An apparatus and computer program product also perform the functions of the method. The method includes receiving, from a user device, a first authentication request for a first service provider and forwarding, to the first service provider, the first authentication request. The method includes receiving, from the first service provider, a first session token and sending, to the user device, a unified session token, the unified session token is derived based at least in part on the first session token. The method includes providing the user device an access to a second service provider based at least in part on receiving a second authentication request and the unified session token from the user device and the user device having access to the first service provider.

### FIELD

The subject matter disclosed herein relates to user session aggregator and more particularly relates to user session aggregator using different IDPs and different session management protocols.

### BACKGROUND

In the context of multiple service providers inside a network system, each service provider has its own user authentication mechanism. Due to this reason, the user needs to initiate a user session with each service provider separately. Further, the service providers may use the same hypertext transfer protocol (“HTTP”) header values for transporting the user authentication tokens. This may lead to overriding the HTTP header values. Furthermore, when a user device initiates a user session with each of the service providers, the user device receives and holds all of the authentication tokens. These authentication tokens may include sensitive information such as user information. Receiving these authentication token at the user device gives rise to security or privacy concerns.

### BRIEF SUMMARY

A method for user session aggregator using different IDPs and different session management protocols is disclosed. An apparatus and computer program product also perform the functions of the method. The method includes receiving, from a user device, a first authentication request for a first service provider and forwarding, to the first service provider, the first authentication request. The method includes receiving, from the first service provider, a first session token and sending, to the user device, a unified session token, the unified session token is derived based at least in part on the first session token. The method includes providing the user device an access to a second service provider based at least in part on receiving a second authentication request and the unified session token from the user device and the user device having access to the first service provider.

An apparatus for user session aggregator using different IDPs and different session management protocols includes a processor and non-transitory computer readable storage media storing code. The code is executable by the processor to perform operations that include receiving, from a user device, a first authentication request for a first service provider and forwarding, to the first service provider, the first authentication request. The operations include receiving, from the first service provider, a first session token and sending, to the user device, a unified session token, the unified session token is derived based at least in part on the first session token. The operations include providing the user device an access to a second service provider based at least in part on receiving a second authentication request and the unified session token from the user device and the user device having access to the first service provider.

A program product for edge deployment with single touch point includes a non-transitory computer readable storage medium storing code. The code is configured to be executable by a processor to perform operations that include receiving, from a user device, a first authentication request for a first service provider and forwarding, to the first service provider, the first authentication request. The operations include receiving, from the first service provider, a first session token and sending, to the user device, a unified session token, the unified session token is derived based at least in part on the first session token. The operations include providing the user device an access to a second service provider based at least in part on receiving a second authentication request and the unified session token from the user device and the user device having access to the first service provider.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for user session aggregator using different IDPs and different session management protocols, according to various embodiments;

FIG. 2 is a schematic block diagram illustrating an apparatus for user session aggregator using different IDPs and different session management protocols, according to various embodiments;

FIG. 3 is a schematic block diagram illustrating another apparatus for user session aggregator using different IDPs and different session management protocols, according to various embodiments;

FIG. 4 is a schematic flowchart diagram illustrating a method for user session aggregator using different IDPs and different session management protocols, according to various embodiments; and

FIG. 5 is a schematic flowchart diagram illustrating another method for user session aggregator using different IDPs and different session management protocols, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

A method for user session aggregator using different IDPs and different session management protocols is disclosed. An apparatus and computer program product also perform the functions of the method. The method includes receiving, from a user device, a first authentication request for a first service provider and forwarding, to the first service provider, the first authentication request. The method includes receiving, from the first service provider, a first session token and sending, to the user device, a unified session token, the unified session token is derived based at least in part on the first session token. The method includes providing the user device an access to a second service provider based at least in part on receiving a second authentication request and the unified session token from the user device and the user device having access to the first service provider.

In some embodiments, providing the user device an access to the second service provider further includes forwarding, to the second service provider, the second authentication request in response to receiving the second authentication request and the unified session token from the user device and receiving, from the second service provider, a second session token. In some embodiments the method includes storing the first session token in a unified session store in response to receiving the first session token from the first service provider and storing the second session token in the unified session store in response to receiving the second session token from the second service provider.

In some embodiments, the unified session token includes a unique identifier which points to the unified session store. In some embodiments, the method includes redirecting the user device to access the first service provider in response to the user device making an attempt to access the second service provider without having access to the first service provider.

In some embodiments, redirecting the user device to access the first service provider includes sending, to the user device, a pop-up message indicating the user to access the first service provider before accessing the second service provider. In some embodiments, the method includes, providing user device access to a third service provider based at least in part on receiving a third authentication request and the unified session token from the user device and the user device having access to the first service provider and the second service provider.

In some embodiments, the user device is provided access to the third service provider based on the user device having access to the first service provider and/or the user device having access to the second service provider. In some embodiments, the method is performed by a unified identity provider (“UIdP”). In some embodiments, the user device, the UIdP, the first service provider, and the second service provider are in the same network.

An apparatus for user session aggregator using different IDPs and different session management protocols includes a processor and non-transitory computer readable storage media storing code. The code is executable by the processor to perform operations that include receiving, from a user device, a first authentication request for a first service provider and forwarding, to the first service provider, the first authentication request. The operations include receiving, from the first service provider, a first session token and sending, to the user device, a unified session token, the unified session token is derived based at least in part on the first session token. The operations include providing the user device an access to a second service provider based at least in part on receiving a second authentication request and the unified session token from the user device and the user device having access to the first service provider.

In some embodiments, providing the user device an access to the second service provider further includes forwarding, to the second service provider, the second authentication request in response to receiving the second authentication request and the unified session token from the user device and receiving, from the second service provider, a second session token. In some embodiments the operations include storing the first session token in a unified session store in response to receiving the first session token from the first service provider and storing the second session token in the unified session store in response to receiving the second session token from the second service provider.

In some embodiments, the unified session token includes a unique identifier which points to the unified session store. In some embodiments, the operations include redirecting the user device to access the first service provider in response to the user device making an attempt to access the second service provider without having access to the first service provider.

In some embodiments, redirecting the user device to access the first service provider includes sending, to the user device, a pop-up message indicating the user to access the first service provider before accessing the second service provider. In some embodiments, the operations include, providing user device access to a third service provider based at least in part on receiving a third authentication request and the unified session token from the user device and the user device having access to the first service provider and the second service provider.

In some embodiments, the user device is provided access to the third service provider based on the user device having access to the first service provider and/or the user device having access to the second service provider. In some embodiments, the operations are performed by a UIdP. In some embodiments, the user device, the UIdP, the first service provider, and the second service provider are in the same network.

A program product for edge deployment with single touch point includes a non-transitory computer readable storage medium storing code. The code is configured to be executable by a processor to perform operations that include receiving, from a user device, a first authentication request for a first service provider and forwarding, to the first service provider, the first authentication request. The operations include receiving, from the first service provider, a first session token and sending, to the user device, a unified session token, the unified session token is derived based at least in part on the first session token. The operations include providing the user device an access to a second service provider based at least in part on receiving a second authentication request and the unified session token from the user device and the user device having access to the first service provider.

In some embodiments, providing the user device an access to the second service provider further includes forwarding, to the second service provider, the second authentication request in response to receiving the second authentication request and the unified session token from the user device and receiving, from the second service provider, a second session token. In some embodiments the operations include storing the first session token in a unified session store in response to receiving the first session token from the first service provider and storing the second session token in the unified session store in response to receiving the second session token from the second service provider.

In some embodiments, the unified session token includes a unique identifier which points to the unified session store. In some embodiments, the operations include redirecting the user device to access the first service provider in response to the user device making an attempt to access the second service provider without having access to the first service provider.

In some embodiments, redirecting the user device to access the first service provider includes sending, to the user device, a pop-up message indicating the user to access the first service provider before accessing the second service provider. In some embodiments, the operations include providing user device access to a third service provider based at least in part on receiving a third authentication request and the unified session token from the user device and the user device having access to the first service provider and the second service provider.

In some embodiments, the user device is provided access to the third service provider based on the user device having access to the first service provider and/or the user device having access to the second service provider. In some embodiments, the operations are performed by a UIdP. In some embodiments, the user device, the UIdP, the first service provider, and the second service provider are in the same network.

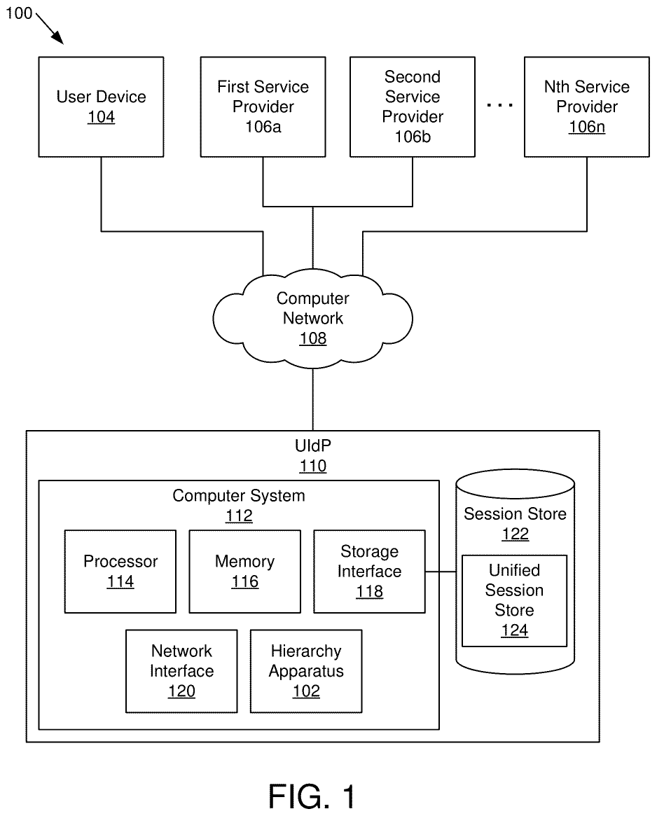

FIG. 1 is a schematic block diagram illustrating a system 100 for user session aggregator using different Identity Providers (“IdPs”) and different session management protocols, according to various embodiments. The system 100 includes a hierarchy apparatus 102, a user device 104, a first service provider 106a, a second service provider 106b, an n^{th} service provider 106n, a computer network 108, and a Unified Identity Provider (“UIdP”) 110. The UIdP 110 further includes a computer system 112, and a session store 122 with a unified session store 124. The computer system 112 includes the hierarchy apparatus 102, a processor 114, a memory 116, a storage interface 118, and a network interface 120.

In the context of multiple service providers (e.g., 106a-106n) inside a network system, each service provider (e.g., 106a-106n) has its own user authentication mechanism. Due to this reason, the user needs to initiate a user session with each service provider (e.g., 106a-106n) separately. Further, the service providers (e.g., 106a-106n) may use the same HTTP header values for transporting the user authentication tokens. This may lead to overriding the HTTP header values. Furthermore, when a user device 104 initiates a user session with each of the service providers (e.g., 106a-106n), the user device 104 receives and holds all of the authentication tokens. These authentication tokens may include sensitive information such as user information. Receiving these authentication token at the user device 104 gives rise to security or privacy concerns.

The hierarchy apparatus 102 enables a user device 104 to initiate a user session with a second service provider 106b via the first service provider 106a by creating a hierarchy and aggregating all user sessions under a unified sign-on session. More specifically, the hierarchy apparatus 102 enables the user device 104 to initiate a user session with the second service provider 106b only if the user device 104 is already authenticated in the first service provider 106a.

In some embodiments, the hierarchy apparatus 102 receives from a user device 104, a first authentication request for a first service provider 106a. The user device 104 may be for example, but not limited to, a laptop, a mobile phone, a smartphone, a tablet, etc. The first service provider 106a may be, for example, an application. In some embodiments, the first service provider 106a may be a legacy application. In some embodiments, the first service provider 106a may be an application for which changing the source code is impossible or costly. In some embodiments, the first service provider may be XClarity One (“XC1”) by Lenovo.

In some embodiments, the hierarchy apparatus 102 forwards, to the first service provider 106a, the first authentication request. In some embodiments, the hierarchy apparatus 102 receives, from the first service provider 106a, a first session token. The first session token may be for example, but not limited to a JavaScript Object Notation (“JSON”) Web Token (“JWT”), Platform-Agnostic Security Tokens (“PASETO”), Open Authorization (“OAuth2”), OpenID Connect, Security Assertion Markup Language (“SAML”), etc., that securely transmits information between applications or services.

In some embodiments, the hierarchy apparatus 102 sends, to the user device 104, a unified session token. In some embodiments, the unified session token is derived based at least in part on the first session token. In some embodiments, the hierarchy apparatus 102 stores the first session token in a unified session store 124 in response to receiving the first session token from the first service provider 106a. In some embodiments, the unified session store 124 may be, for example, a storage area within the session store 122 allocated for a particular user device 104 in response to the user device 104 authenticating with the first service provider 106a. In some embodiments, the unified session token includes a unique identifier which points to the unified session store 124. In some embodiments, the unified session token may include authentication information and exclude sensitive information.

In some embodiments, the hierarchy apparatus 102 provides the user device 104 an access to a second service provider 106b based at least in part on receiving a second authentication request and the unified session token from the user device 104 and the user device 104 having access to the first service provider 106a. For example, the hierarchy apparatus provides the user device 104 an access to the second service provider 106b only if the user device 104 has already established a connection with the first service provider 106a and presents the unified session token provided by the hierarchy apparatus 102. For example, the hierarchy apparatus 102 provides user device 104 access to the second service provider 106b only if the user device 104 presents the unified session token along with the second authentication request. In some embodiments, the unified session token acts as a proof that the user device 104 has already authenticated with the first service provider 106a. In some embodiments, the second service provider 106b may be XClarity Controller (“XCC”) by Lenovo.

In some embodiments, the first service provider may be, for example, a game hub and the second service provider may be, for example, a minigame application within the game hub. In some embodiments, the first service provider may be, for example, a social media application and the second service provider may be, for example, a messaging application.

In some embodiments, the hierarchy apparatus 102 may establish a hierarchy between the first service provider 106a and the second service provider 106b. For example, the hierarchy apparatus 102 may identify the first service provider 106a as a most significant service provider. For example, the hierarchy apparatus 102 may designate the first service provider 106a as the parent service provider and the second service provider 106b as the child service provider. In some embodiments, establishing the hierarchy may include establishing a set of rules for providing user device 104 access to the service providers (e.g., 106a-106n).

In some embodiments, the hierarchy apparatus 102 forwards, to the second service provider 106b, the second authentication request in response to receiving the second authentication request and the unified session token from the user device 104. In some embodiments, the hierarchy apparatus 102 forwards, to the second service provider 106b, the second authentication request and the unified session token in response to receiving the second authentication request and the unified session token from the user device 104. In some embodiments, the hierarchy apparatus 102 receives, from the second service provider 106b, a second session token. In some embodiments, the hierarchy apparatus 102 stores the second session token in the unified session store 124 in response to receiving the second session token from the second service provider 106b.

In some embodiments, the hierarchy apparatus 102 redirects the user device 104 to access the first service provider 106a in response to the user device 104 making an attempt to access the second service provider 106b without having access to the first service provider 106a. In some embodiments, redirecting the user device 104 to access the first service provider 106a includes sending, to the user device 104, a pop-up message indicating the user of the user device 104 to access the first service provider 106a before accessing the second service provider 106b.

In some embodiments, the hierarchy apparatus 102 provides user device 104 access to a third service provider (e.g., 106c) based at least in part on receiving a third authentication request and the unified session token from the user device and the user device having the access to the first service provider 106a and the second service provider 106b. In some embodiments, the user device is provided access to the third service provider 106c based on the user device 104 having access to the first service provider 106a and/or the user device 104 having access to the second service provider 106b. In some embodiments, the hierarchy apparatus 102 may establish one or more rules that define a criteria for allowing the user device 104 to access the third service provider 106c. In some embodiments, the user device 104, the UIdP 110, the first service provider 106a, the second service provider 106b, and the third service provider 106c are in the same network.

The system 100 includes UIdP 110 that includes the computer system 112 and the session store 122. The UIdP 110, in some embodiments acts as an orchestrator between the user device 104 and the service providers (e.g., 106a-106n) which aggregates user sessions. The UIdP 110, in some embodiments, may include one or more Identity Providers (“IdPs”). It should be noted that the UIdP 110 as illustrated and hereinafter described is merely illustrative of an apparatus that could benefit from embodiments of the present disclosure and, therefore, should not be taken to limit the scope of the present disclosure. It should be noted that the UIdP 110 may include fewer or more components than those depicted in FIG. 1.

The computer system 112 includes the hierarchy apparatus 102, the processor 114, the memory 116, the storage interface 118 and the network interface 120. The computer system 112 may further include, in general, a non-volatile memory, communication buses, etc. The computer system 112 may be for example, but not limited to, a server device, a tower server, a blade server, a rack-mounted server, desktop computers, or a workstation. The network interface 120 may be, for example, Network Interface Card (“NIC”). The storage interface 118 enables the processor 114 to have access to the session store 122. The storage interface 118 may be for example, but not limited to, an Advanced Technology Attachment (“ATA”) adapter, a Serial ATA (“SATA”) adapter, a Small Computer System Interface (“SCSI”) adapter, a RAID controller, a SAN adapter, a network adapter, and/or any component providing the processor 114 with access to the session store 122. In some embodiments, the computer system 112 may be a cloud computing system which includes one or more computing devices.

The system 100 includes a first service provider 106a and a second service provider 106b. In some embodiments, the system 100 may include a third service provider 106c. In some embodiments, the system 100 may include two or more service providers (e.g., 106a-106n). The service providers (e.g., 106a-106n) may be, for example, but not limited to software applications. The service providers (e.g., 106a-106n), in some embodiments, provide one or more services to the user device 104. In some embodiments, each of the service providers (e.g., 106a-106n) may receive an authentication request from the user device 104 via the UIdP 110. In some embodiments, each of the service providers (e.g., 106a-106n) may transmit a session token to the UIdP 110 based on the received authentication request and/or a successful authentication of the user device 104. In general, a session token is a unique string of data that identifies a user's session when the user logs into a website or application. In various embodiments the service providers (e.g., 106a-106n) are connected to the UIdP 110 via the computer network 108.

The system 100 includes a user device 104 which sends an authentication request to the UIdP 110 when a user desires to use a particular service provider (e.g., 106a). For example, when a user desires to use a first application, the user device 104 sends to the UIdP 110 a first authentication request for the first service provider 106a. When a user desires to use a second application, the user device 104 sends, to the UIdP 110, a second authentication request for the second service provider 106b. In some embodiment, the user device 104 receives a unified session token from the UIdP 110 only in response to sending an authentication request to the first service provider 106a. In some embodiments, the user device 104 receives a unified session token from the UIdP 110 only in response to sending the authentication request to the parent service provider (e.g., 106a). In various embodiments, the user device 104 is connected to the UIdP 110 via the computer network 108.

The system 100 includes a session store 122 which may be for example, a secure database that stores the session tokens received from the service providers. The session store 122 may be a cloud database which is hosted by a third-party cloud service provider. In some embodiments, the session store 122, may be a traditional database that stores one or more session tokens in a local server. In some embodiments the session store includes a unified session store 124 configured to store the session tokens received from the service providers (e.g., 106a-106n). In some embodiments the unified session store 124 may be allocated per user device (e.g., 104). In various embodiments, the unified session store 124 is a secured storage area allocated per user device (e.g., 104).

The computer network 108, in some embodiments, includes a LAN, a WAN, a fiber network, a wireless connection, the Internet, or the like. In some embodiments, the computer network 108 includes two or more networks. In some embodiments, the computer network 108 includes servers, wiring, switches, routers, etc.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM” ), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ). Alternatively, the wireless connection may be a cellular telephone network communication. All standards and/or connection types include the latest version and revision of the standard and/or connection type as of the filing date of this application.

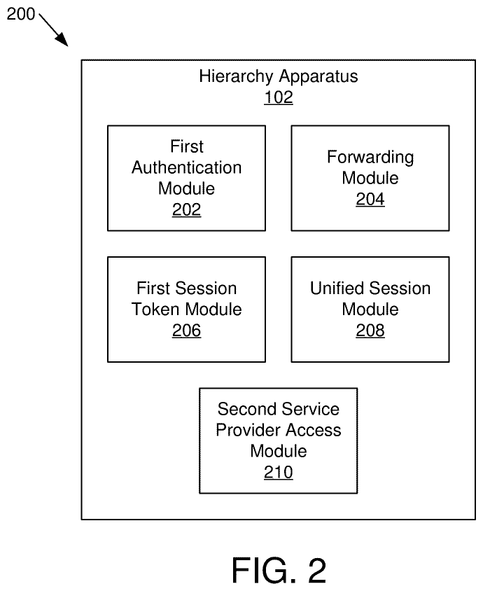

FIG. 2 is a schematic block diagram illustrating an apparatus 200 for user session aggregator using different IDPs and different session management protocols, according to various embodiments. The apparatus 200 includes a first authentication module 202, a forwarding module 204, a first session token module 206, a unified session module 208, and a second service provider access module 210. In some embodiments, the apparatus 200 is implemented using executable code stored on a computer readable storage device, which is non-transitory. The code is executable on a processor. In other embodiments, all, or a portion of the apparatus 200 is implemented using a programmable hardware device and/or hardware circuits.

The apparatus 200 includes a first authentication module 202 configured to receive from a user device 104, a first authentication request for a first service provider 106a. In some embodiments, first authentication request may include a request to access the first service provider 106a. In some embodiments, the first authentication request may include an identifier that indicates that the authentication request is for the first service provider 106a.

The apparatus 200 includes a forwarding module 204 configured to forward the first authentication request received at the UIdP 110 to the first service provider 106a. In some embodiments, the forwarding module 204 may forward only the authentication request received for the first service provider 106a. In some embodiments, the forwarding module 204 may forward the first authentication request in response to receiving the first authentication request for the first service provider 106a. In some embodiments, the forwarding module 204 may forward the first authentication request to the first service provider 106a in response to receiving an authentication request that includes the identifier that indicates that the authentication request is for the first service provider 106a.

The apparatus 200 includes a first session token module 206 configured to receive, from the first service provider 106a, a first session token. The first session token module 206 may be configured to receive the first session token in response to the forwarding module 204 forwarding the first authentication request. In some embodiments, the first session token may include a unique string that identifies a user's session when the user logs into the first service provider 106a. In some embodiments, the first session token may include sensitive information. In some embodiments, the first session token may be a JWT. In general, JWT defines a compact and self-contained way for securely sending information between parties as a JSON object. This information can be verified and trusted because the information is digitally signed. In some embodiments, the first session token may be, for example, Platform-Agnostic Security Tokens (“PASETO”), Open Authorization (“OAuth2”), OpenID Connect, Security Assertion Markup Language (“SAML”), etc.

The apparatus 200 includes a unified session module 208 configured to send, to the user device 104, a unified session token, the unified session token is derived based at least in part on the first session token. In some embodiments, the unified session module 208 is configured to derive the unified session token based on the received first session token. In some embodiments, the unified session module 208 derives the unified session token in response to receiving a session token from the first service provider 106a. In some embodiments, the unified session module 208 derives the unified session token in response to receiving a session token from the parent service provider (e.g., 106a).

In some embodiments, the unified session token may be a unique identifier which points to the unified session store 124. In some embodiments, the unified session token may include a pointer which points to the unified session store 124. In some embodiments, the unified session store 124 may be a storage area allocated for a particular user device 104. In some embodiments, the unified session module 208, does not include sensitive information in the unified session token. In some embodiments, the unified session token may include a message to the user device 104 that indicates the user device 104 to use the unified session token while authenticating with the other service providers (e.g., 106a-106n). In some embodiments, the unified session module 208 may send the message, separately from the unified session token, to the user device 104 that indicates the user device 104 to use the unified session token while authenticating with the other service providers (e.g., 106a-106n).

The apparatus 200 includes a second service provider access module 210 configured to provide the user device 104 an access to the second service provider 106b based at least in part on receiving a second authentication request and the unified session token from the user device 104 and the user device 104 having access to the first service provider 106a. In some embodiments, the second service provider access module 210 is configured to determine based on the unified session token received from the user device 104 if the user device 104 was previously authenticated by the first service provider 106a. In some embodiments, the second service provider access module 210 determines that the user device 104 was previously authenticated by the first service provider 106a in response to the unified session token including the unique identifier that points to the unified session store 124. In some embodiments, the second service provider access module 210 determines that the user device was previously authenticated with the first service provider in response to the unified session token including a pointer that points to the unified session store 124.

In some embodiments, the second service provider access module 210 is configured to forward, to the second service provider 106b, the second authentication request in response to receiving the second authentication request and the unified session token from the user device 104. In some embodiments, the second service provider access module 210 may indicate the second service provider 106b that the user device was previously authenticated by the first service provider 106a. In some embodiments, the second service provider access module 210 is configured to receive, from the second service provider 106b, a second session token.

In some embodiments, the second service provider access module 210 is configured to provide user device 104 access to a third service provider 106c based at least in part on receiving a third authentication request and the unified session token from the user device 104 and the user device 104 having the access to the first service provider 106a and the second service provider 106b. In some embodiments, the second service provider access module 210 is configured to provide the user device 104 access to the third service provider 106c based on the user device 104 having access to the first service provider 106a and/or the user device 104 having access to the second service provider 106b.

In some embodiments, the second service provider access module 210 is configured to provide user device 104 access to the second service provider 106b based on a hierarchy established by a hierarchy establishment module (not shown). In some embodiments, the second service provider access module 210 is configured to provide user device 104 access to the second service provider 106b based on a set of rules established for accessing the second service provider 106b by the hierarchy establishment module (not shown). In some embodiments, the second service provider access module 210 may store the second session tokens received from the second service provider 106b and the third session tokens received from the third service provider 106c in the unified session store 124.

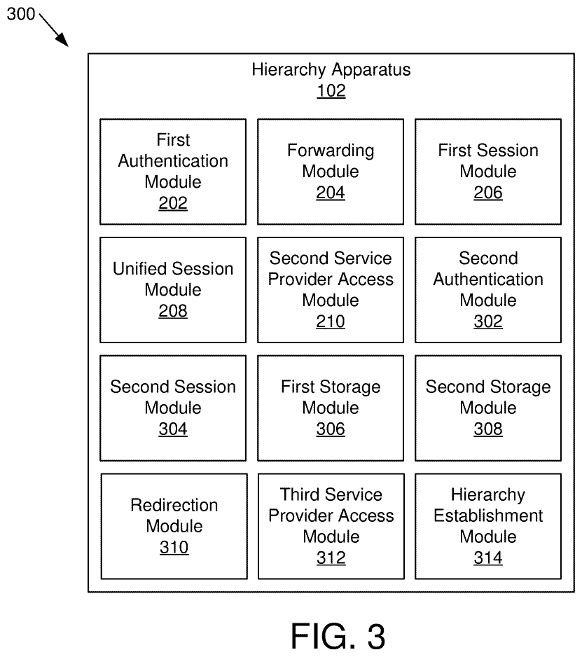

FIG. 3 is a schematic block diagram illustrating another apparatus 300 for user session aggregator using different IDPs and different session management protocols, according to various embodiments. The apparatus 300 includes a first authentication module 202, a forwarding module 204, a first session token module 206, a unified session module 208, and a second service provider access module 210 which are substantially similar to those described above in relation to the apparatus 200 of FIG. 2. The hierarchy apparatus 102 includes, in various embodiments, a second authentication module 302, a second session module 304, a third service provider access module 312, a first storage module 306, a second storage module 308, a redirection module 310 and/or a hierarchy establishment module 314. In some embodiments, the apparatus 300 is implemented using executable code stored on a computer readable storage device, which is non-transitory. The code is executable on a processor. In other embodiments, all, or a portion of the apparatus 200 is implemented using a programmable hardware device and/or hardware circuits.

The apparatus 300, in some embodiments, includes a second authentication module 302 configured to forward, to the second service provider 106b, the second authentication request in response to receiving the second authentication request and the unified session token from the user device 104. In some embodiments, the second authentication module 302 may be configured to forward the second authentication request in response to detecting that the unique identifier points to the unified session store 124.

The apparatus 300, in some embodiments, includes a second session module 304 configured to receive, from the second service provider 106b a second session token. In some embodiments, the second session token may include a unique string that identifies a user's session when the user logs into the second service provider 106b. In some embodiments, the second session token may include sensitive information. In some embodiments, the second session token may be, for example, a JWT. It should be noted that the first session token sent from the first service provider 106a is different from the second session token sent from the second service provider 106b. In some embodiments the second service provider access module 210 may provide the user device 104 access to the second service provider 106b in response to the second session module 304 receiving the second session token. It should be noted that the second session module 304 does not send the second session token to the user device 104.

The apparatus 300, in some embodiments, includes a first storage module 306, configured to store the first session token in the unified session store 124. In some embodiments, the first storage module 306 stores the first session token in response to receiving the first session token from the first service provider 106a.

The apparatus 300, in some embodiments, includes a second storage module 308, configured to store the second session token in the unified session store 124. In some embodiments, the second storage module 308 stores the second session token in response to receiving the second session token from the second service provider 106b. In some embodiments, the first storage module 306 and/or the second storage module 308 may link the first session token and the second session token to the unified session token in the unified session store 124.

The apparatus 300, in some embodiments, includes a redirection module 310 configured to redirect the user device 104 to access the first service provider 106a in response to the user device 104 making an attempt to access the second service provider 106b without having access to the first service provider 106a. In some embodiments, redirecting the user device 104 to access the first service provider 106a includes sending, to the user device 104, a pop-up message indicating the user of the user device 104 to access the first service provider 106a before accessing the second service provider 106b. In other embodiments, redirecting the user device 104 to access the first service provider 106a includes sending, to the user device 104, an email and/or a text message indicating the user of the user device 104 to access the first service provider 106a before accessing the second service provider 106b.

The apparatus 300, in some embodiments, includes a third service provider access module 312 configured to provide user device 104 access to a third service provider 106c based at least in part on receiving a third authentication request and the unified session token from the user device 104 and the user device having the access to the first service provider 106a and/or the second service provider 106b. In some embodiments, user device 104 is provided access to the third service provider 106c based on the user device 104 having access to the first service provider 106a, the user device 104 having access to the second service provider 106b, or both. In some embodiments, the third service provider access module 312 is configured to provide user device access to the third service provider 106c based on a hierarchy established by the hierarchy establishment module (not shown). In some embodiments, the third service provider access module 312 is configured to provide user device 104 access to the third service provider 106c based on a set of rules established by the hierarchy establishment module (not shown) for accessing the third service provider 106c.

The apparatus 300, in some embodiments, may include a third authentication module (not shown), a third session module (not shown), and a third storage module (not shown) which is substantially similar to the second authentication module 302, the second session module 304, and the second storage module 308 respectively. In some embodiments the third authentication module (not shown) is configured to forward the third authentication request to the third service provider in response to the user device having access to the first service provider and/or the second service provider.

A person having ordinary skill in the art will recognize that the apparatus 300 may include fewer or more modules based on the number of service providers (e.g., 106a-106n) present in the system 100. For example, the apparatus 300 may include a fourth service provider access module (not shown), a fourth authentication module (not shown), a fourth session module (not shown), and a fourth storage module (not shown) in response to the system 100 including a fourth service provider 106d.

The apparatus 300, in some embodiments, may include a hierarchy establishment module 314, configured to establish a hierarchy between the service providers (e.g., 106a-106n). In some embodiments, the hierarchy establishment module 314 may establish a hierarchy between the service providers (e.g., 106a-106n) based on a user input, a system administrator input, a manufacturer information, etc. In some embodiments, the hierarchy establishment module 314 may establish one or more rules for accessing each of the service providers (e.g., 106a-106n).

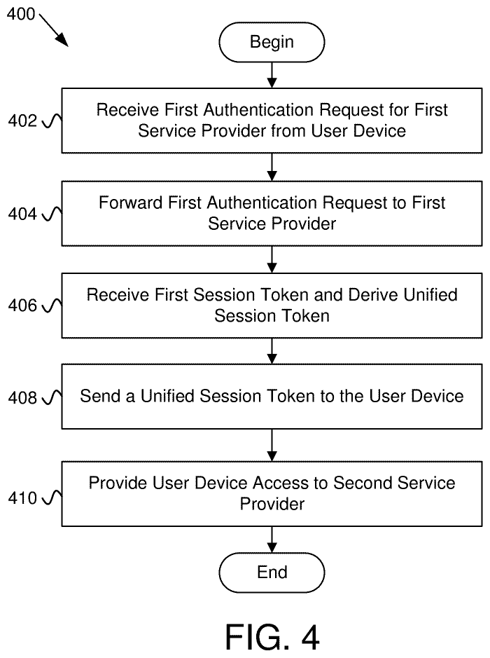

FIG. 4 is a schematic flowchart diagram illustrating a method 400 for user session aggregator using different IDPs and different session management protocols, according to various embodiments. The method 400 begins and receives 402, from a user device 104, a first authentication request for a first service provider 106a. The method 400 forwards 404, to the first service provider 106a, the first authentication request and receives 406, from the first service provider 106a, a first session token. The method 400 sends 408, to the user device 104, a unified session token, where the unified session token is derived based at least in part on the first session token. In some embodiments, the method 400 provides 410 the user device 104 an access to a second service provider 106b based at least in part on receiving a second authentication request and the unified session token from the user device 104 and the user device 104 having an access to the first service provider 106a and the method 400 ends. In various embodiments, all or a portion of the method 400 is implemented using the first authentication module 202, the forwarding module 204, the first session token module 206, the unified session module 208, and/or the second service provider access module 210.

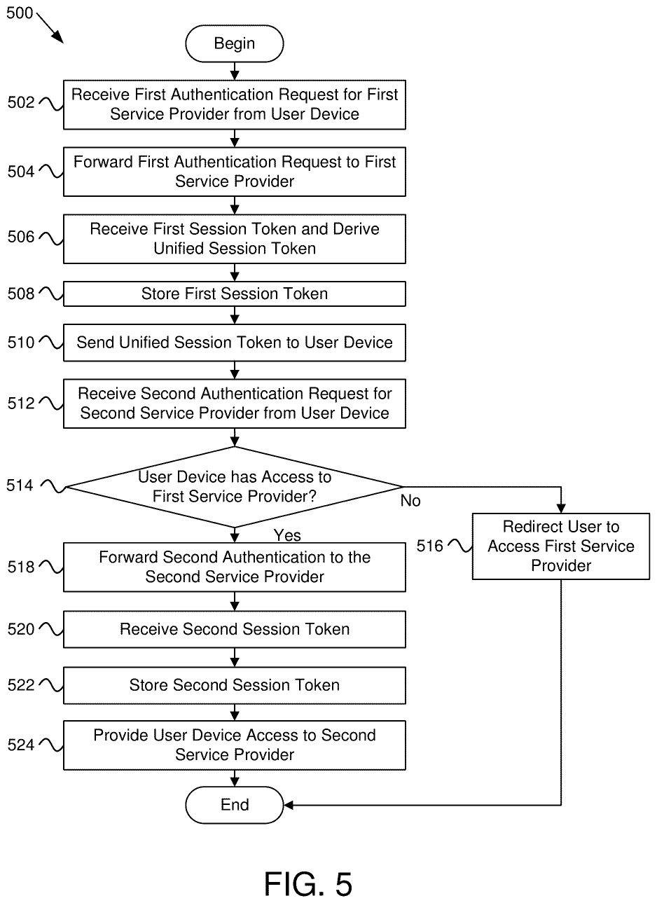

FIG. 5 is a schematic flowchart diagram illustrating another method 500 for user session aggregator using different IDPs and different session management protocols, according to various embodiments. The method 500 begins and receives 502, from a user device 104, a first authentication request for a first service provider 106a. The method 500 forwards 504, to the first service provider 106a, the first authentication request and receives 506, from the first service provider 106a, a first session token. The method 500 stores 508 the first session token in a unified session store 124 in response to receiving the first session token from the first service provider 106a. The method 500 sends 510, to the user device 104, a unified session token, where the unified session token is derived based at least in part on the first session token.

The method 500 receives 512 a second authentication request for the second service provider 106b from the user device 104 and determines 514 whether the user device 104 has access to the first service provider 106a. In response to determining that the user device 104 does not have access to the first service provider 106a, the method 500 redirects 516 the user device 104 to access the first service provider 106a, and the method 500 ends. In response to determining that the user device 104 has access to the first service provider 106a, the method 500 forwards 518, the second authentication request to the second service provider 106b and receives 520 a second session token from the second service provider 106b.

The method 500 stores 522, the second session token in the unified session store 124 and provides 524 the user device 104 an access to a second service provider 106b based at least in part on receiving 512 a second authentication request and the unified session token from the user device 104 and determining that the user device 104 has access to the first service provider, and the method 500 ends. In various embodiments, all or a portion of the method 500 is implemented using the first authentication module 202, the forwarding module 204, the first session token module 206, the unified session module 208, the second service provider access module 210, the second authentication module 302, the second session module 304, the third service provider access module 312, the first storage module 306, the second storage module 308, the redirection module 310 and/or the hierarchy establishment module 314.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, from a user device, a first authentication request for a first service provider;
forwarding, to the first service provider, the first authentication request;
receiving, from the first service provider, a first session token;
sending, to the user device, a unified session token, wherein the unified session token is derived based at least in part on the first session token; and
providing the user device an access to a second service provider based at least in part on receiving a second authentication request and the unified session token from the user device and the user device having an access to the first service provider.

2. The method of claim 1, wherein providing the user device an access to the second service provider further comprises:
forwarding, to the second service provider, the second authentication request in response to receiving the second authentication request and the unified session token from the user device; and
receiving, from the second service provider, a second session token.

3. The method of claim 2, further comprising:
storing the first session token in a unified session store in response to receiving the first session token from the first service provider; and
storing the second session token in the unified session store in response to receiving the second session token from the second service provider.

4. The method of claim 3, wherein the unified session token comprises a unique identifier which points to the unified session store.

5. The method of claim 1, further comprising redirecting the user device to access the first service provider in response to the user device making an attempt to access the second service provider without having access to the first service provider.

6. The method of claim 5, wherein redirecting the user device to access the first service provider comprises sending, to the user device, a pop-up message indicating the user to access the first service provider before accessing the second service provider.

7. The method of claim 1, further comprising providing user device access to a third service provider based at least in part on receiving a third authentication request and the unified session token from the user device and the user device having the access to the first service provider and the second service provider.

8. The method of claim 7, wherein the user device is provided access to the third service provider based on the user device having access to the first service provider and/or the user device having access to the second service provider.

9. The method of claim 1, wherein the method is performed by a unified identity provider (UIdP).

10. The method of claim 9, wherein the user device, the UIdP, the first service provider, and the second service provider are in a same network.

11. An apparatus comprising:
a processor; and
non-transitory computer readable storage media storing code, the code being executable by the processor to perform operations comprising:
receiving, from a user device, a first authentication request for a first service provider;
forwarding, to the first service provider, the first authentication request;
receiving, from the first service provider, a first session token;
sending, to the user device, a unified session token, wherein the unified session token is derived based at least in part on the first session token; and
providing the user device access to a second service provider based at least in part on receiving a second authentication request and the unified session token from the user device and the user device having access to the first service provider.

12. The apparatus of claim 11, providing the user device access to the second service provider comprises:
forwarding, to the second service provider, the second authentication request in response to receiving the second authentication request and the unified session token from the user device; and
receiving, from the second service provider, a second session token.

13. The apparatus of claim 12, the operations further comprising:
storing the first session token in a unified session store in response to receiving the first session token from the first service provider; and
storing the second session token in the unified session store in response to receiving the second session token from the second service provider.

14. The apparatus of claim 13, wherein the unified session token comprises a unique identifier which points to the unified session store.

15. The apparatus of claim 11, the operations further comprising redirecting the user device to access the first service provider in response to the user device making an attempt to access the second service provider without having access to the first service provider.

16. The apparatus of claim 11, the operations further comprising providing user device access to a third service provider based at least in part on receiving a third authentication request and the unified session token from the user device and the user device having access to the first service provider and the second service provider.

17. The apparatus of claim 16, wherein the user device is provided access to the third service provider based on the user device having access to the first service provider and/or the user device having access to the second service provider.

18. The apparatus of claim 11, wherein the operations are performed by a unified identity provider (UIdP).

19. The apparatus of claim 18, wherein the user device, the UIdP, the first service provider, and the second service provider are in a same network.

20. A program product comprising a non-transitory computer readable storage medium storing code, the code being configured to be executable by a processor to perform operations comprising:
receiving, from a user device, a first authentication request for a first service provider;
forwarding, to the first service provider, the first authentication request;
receiving, from the first service provider, a first session token;
sending, to the user device, a unified session token, wherein the unified session token is derived based at least in part on the first session token; and
providing the user device an access to a second service provider based at least in part on receiving a second authentication request and the unified session token from the user device and the user device having access to the first service provider.
